(19) United States
(12) Patent Application Publication
(10) Pub. No.: US 2010/0033999 A1
(43) Pub. Date: Feb. 11, 2010

(54) LOW-POWER RADIO FREQUENCY DIRECT CURRENT RECTIFIER

(75) Inventors: Joon Hyung Lim, Gunpo (KR); Tah Joon Park, Suwon (KR); Myeung Su Kim, Suwon (KR); Kyung Hee Hong, Seoul (KR); Yong II Kwon, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/332,265

(22) Filed: Dec. 10, 2008

(30) Foreign Application Priority Data
Aug. 8, 2008 (KR) 10-2008-0078008

(51) Int. Cl. H02M 7/217

(52) U.S. Cl. 363/127

(57) ABSTRACT

Provided is a low-power radio frequency (RF) direct current (DC) rectifier. The low-power RF DC rectifier includes a rectification circuit with first and second to n-th rectification units sequentially rectifying an RF signal input through a first input terminal and a second input terminal. The first rectification unit is disposed between the first and second input terminals and a first output terminal of the first rectification unit. The second rectification unit is disposed between the first rectification unit and a second output terminal of the second rectification unit, is biased by the first rectification unit. The n-th rectification unit is disposed between an immediately previous rectification unit and a rectification output terminal of the rectification circuit, is biased by a rectified voltage output from an immediately preceding rectification unit, and outputs the rectified RF signal through the rectification output terminal.

### CROSS-REFERENCE TO RELATED APPLICATIONS

This application claims the priority of Korean Patent Application No. 2008-78008 filed on Aug. 8, 2008, in the Korean Intellectual Property Office, the disclosure of which is incorporated herein by reference.

### BACKGROUND OF THE INVENTION

1. Field of the Invention

The present invention relates to a low-power radio frequency (RF) direct current (DC) rectifier which is applicable to a wake-up receiver, and more particularly, to a low-power RF DC rectifier which is capable of rectifying an RF signal for a wake-up at an ultra-low power (1 μA or less) by implementing repetitive rectification structures by using a native transistor.

2. Description of the Related Art

Generally, one of the most essential functions in the current wireless communication is to use a single dry cell at an ultra-low power for more than several years. To this end, wireless systems must be able to determine whether to perform a wake-up operation by using an ultra-low current consumption (several μA) or keep a deep sleep state.

Meanwhile, a related art RF wake-up configuration detects an RF input signal by using a rectification circuit including a diode and a capacitor. A comparator compares the detected voltage with a reference voltage. When the detected voltage is higher than the reference voltage, the comparator generates a wake-up signal.

However, since such a related art RF rectification circuit must generate the reference voltage to be compared with the detected voltage, additional circuits or costs are required. When a resistance division circuit is used for generating the reference voltage, current consumption increases during resistance division.

Furthermore, when the RF input signal is very large, a comparator circuit may be damaged by an overvoltage generated when a voltage charged into the capacitor is excessive.

### SUMMARY OF THE INVENTION

An aspect of the present invention provides a low-power RF DC rectifier which is capable of rectifying an RF signal for a wake-up at an ultra-low power (1 μA or less) by implementing repetitive rectification structures by using a native transistor.

According to an aspect of the present invention, there is provided a low-power radio frequency (RF) direct current (DC) rectifier, including: a rectification circuit comprising first and second to n-th rectification units sequentially rectifying an RF signal input through a first input terminal and a second input terminal, wherein the first rectification unit is disposed between the first and second input terminals and a first output terminal of the first rectification unit, and rectifies the RF signal and supplies the rectified RF signal to the second rectification unit; the second rectification unit is disposed between the first rectification unit and a second output terminal of the second rectification unit, is biased by the rectified voltage output from the first rectification unit, rectifies the RF signal and supplies the rectified RF signal to an immediately following rectification unit; and the n-th rectification unit is disposed between an immediately previous rectification unit and a rectification output terminal of the rectification circuit, is biased a rectified voltage output from an immediately preceding rectification unit, and rectifies the RF signal and outputs the rectified RF signal through the rectification output terminal.

According to another aspect of the present invention, there is provided a low-power radio RF DC rectifier, including: a rectification circuit comprising first and second to n-th rectification units sequentially rectifying an RF signal input through a first input terminal and a second input terminal; and a voltage limiter unit limiting a voltage above a preset voltage among voltages output from an output terminal of the rectification circuit, wherein the first rectification unit is disposed between the first and second input terminals and a first output terminal of the first rectification unit, and rectifies the RF signal and supplies the rectified RF signal to the second rectification unit; the second rectification unit is disposed between the first rectification unit and a second output terminal of the second rectification unit, is biased by the rectified voltage output from the first rectification unit, and rectifies the RF signal and supplies the rectified RF signal to an immediately following rectification unit; and the n-th rectification unit is disposed between an immediately previous rectification unit and a rectification output terminal of the rectification circuit, is biased by a rectified voltage output from an immediately preceding rectification unit, and rectifies the RF signal and outputs the

The first rectification unit may include: a first input capacitor having one terminal connected to the first input terminal; a first parallel MOS transistor having a source connected to the other terminal of the first input capacitor, and a drain and a gate connected to the second input terminal; a first serial MOS transistor having a drain and a gate connected to the other terminal of the first input capacitor, and a source connected to the first output terminal; and a first output capacitor connected between the first output terminal and the second input terminal.

The second rectification unit may include: a second input capacitor having one terminal connected to the first input terminal; a second parallel MOS transistor having a source connected to the other terminal of the first input capacitor, and a drain and a gate connected to the second output terminal; a second serial MOS transistor having a drain and a gate connected to the other terminal of the second input capacitor, and a source connected to the second output terminal; and a second output capacitor connected between the second output terminal and the second input terminal.

The n-th rectification unit may include: an n-th input capacitor having one terminal connected to the first input terminal; an n-th parallel MOS transistor having a source connected to the other terminal of the n-th input capacitor, and a drain and a gate connected to the rectification output terminal; an n-th serial MOS transistor having a drain and a gate connected to the other terminal of the n-th input capacitor, and a source connected to the rectification output terminal; and an n-th output capacitor connected between the n-th output terminal and the second input terminal.

The first to n-th parallel MOS transistors may be native transistors, and the first to n-th serial MOS transistors may be native transistors.

The voltage limiter unit may include: a voltage detecting unit comprising a plurality of diode-connected MOS transistors connected between a first output terminal connected to the rectification output terminal and a second output terminal connected to the second input terminal, the diode-connected MOS transistors having sources connected to the first output terminal, drains connected to the second output terminals; and a voltage blocking unit comprising a switching MOS transistor having a gate connected to a preset middle node among the MOS transistors of the voltage detecting unit, a drain connected to the first output terminal, and a source connected to the second output terminal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram of an RF DC rectifier according to an embodiment of the present invention;

FIG. 2 is an exemplary diagram of a wake-up receiver employing the RF DC rectifier according to the embodiment of the present invention; and

FIG. 3 is a waveform diagram of the RF signal and the DC output voltage in the RF DC rectifier.

### DETAILED DESCRIPTION OF THE PREFERRED EMBODIMENT

Exemplary embodiments of the present invention will now be described in detail with reference to the accompanying drawings.

The present invention should not be construed as being limited to the embodiments set forth herein; rather, these embodiments are provided so that this disclosure will be thorough and complete, and will fully convey the concept of the invention to those skilled in the art. Like reference numerals in the drawings denote like elements.

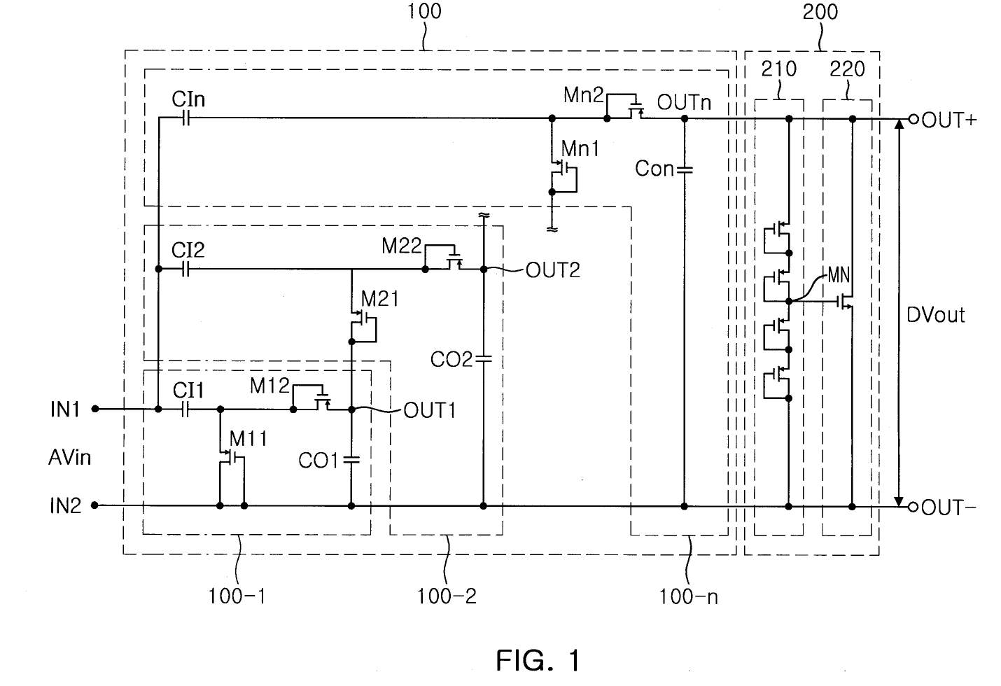

FIG. 1 is a circuit diagram of an RF DC rectifier according to an embodiment of the present invention.

Referring to FIG. 1, the RF DC rectifier includes a rectification circuit 100 with a plurality of rectification units 100-1, 1002, . . . , 100-n sequentially rectifying an RF signal input through a first input terminal IN1 and a second input terminal IN2.

In addition, the RF DC rectifier may further include a voltage limiter unit 200 limiting a voltage above a preset voltage among voltages output from an output terminal OUTn of the rectification circuit 100.

The first rectification unit 100-1 is disposed between the first and second input terminals IN1 and INV2 and a first output terminal OUT1 of the first rectification unit 100-1. The first rectification unit 100-1 rectifies the RF signal and supplies the rectified RF signal to the second rectification unit 100-2.

The second rectification unit 100-2 is disposed between the first rectification unit 100-1 and a second output terminal OUT2 of the second rectification unit 100-2. The second rectification unit 100-2 is biased by the rectified voltage output from the first rectification unit 100-1, rectifies the RF signal and supplies the rectified RF signal to the immediately following rectification unit.

The n-th rectification unit 100-n is disposed between an immediately previous rectification unit and a rectification output terminal OUTn of the rectification circuit 100. The n-th rectification unit 100-n is biased by a rectified voltage output from an immediately preceding rectification unit, rectifies the RF signal and outputs the rectified RF signal through the rectification output terminal OUTn.

The first rectification unit 100-1 includes: a first input capacitor CI1 having one terminal connected to the first input terminal IN1; a first parallel MOS transistor M11 having a source connected to the other terminal of the first input capacitor C11, and a drain and a gate connected to the second input terminal IN2; a first serial MOS transistor M12 having a drain and a gate connected to the other terminal of the first input capacitor C11, and a source connected to the first output terminal OUT1; and a first output capacitor CO1 connected between the first output terminal OUT1 and the second input terminal IN2.

The second rectification unit 100-2 includes: a second input capacitor CI2 having one terminal connected to the first input terminal IN1; a second parallel MOS transistor M21 having a source connected to the other terminal of the first input capacitor CI2, and a drain and a gate connected to the second output terminal OUT2; a second serial MOS transistor M22 having a drain and a gate connected to the other terminal of the second input capacitor CI2, and a source connected to the second output terminal OUT2; and a second output capacitor CO2 connected between the second output terminal OUT2 and the second input terminal IN2.

The n-th rectification unit 100-n includes: an n-th input capacitor CIn having one terminal connected to the first input terminal IN1; an n-th parallel MOS transistor Mn1 having a source connected to the other terminal of the n-th input capacitor CIn, and a drain and a gate connected to the rectification output terminal OUTn; an n-th serial MOS transistor Mn2 having a drain and a gate connected to the other terminal of the n-th input capacitor CIn, and a source connected to the rectification output terminal OUTn; and an n-th output capacitor COn connected between the n-th output terminal OUTn and the second input terminal IN2.

The first to n-th parallel MOS transistors M11, M21, . . . , Mn1 may be native transistors, and the first to n-th serial MOS transistors M12, M22, . . . , Mn2 may be native transistors. The native transistor is supported in a CMOS process, has a native threshold voltage of about 0.05 V, and can be turned on at a small DC input.

The voltage limiter unit 200 includes a voltage detecting unit 210 and a voltage blocking unit 220.

The voltage detecting unit 210 includes a plurality of diode-connected MOS transistors connected in series between a first output terminal OUT+ connected to the rectification output terminal OUTn and a second output terminal OUT− connected to the second input terminal IN2. Each source of the MOS transistors is connected to the first output terminal OUT+, and each drain of the MOS transistors is connected to the second output terminal OUT−.

The voltage blocking unit 220 includes a switching MOS transistor having a gate connected to a preset middle node MN of the MOS transistors of the voltage detecting unit 210, a drain connected to the first output terminal OUT+, and a source connected to the second output terminal OUT−.

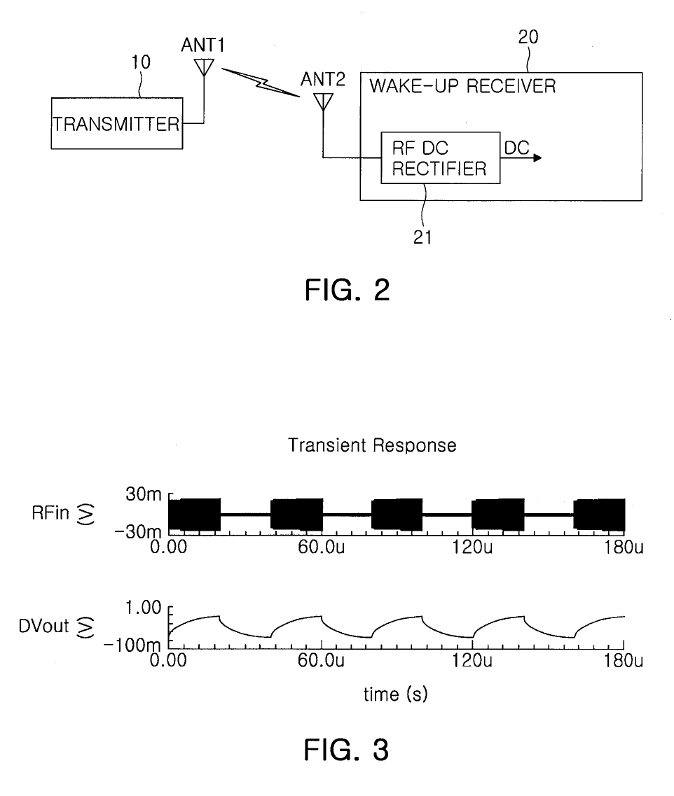

FIG. 2 is an exemplary diagram of a wake-up receiver employing the RF DC rectifier according to the embodiment of the present invention.

Referring to FIG. 2, the wake-up receiver 20 employing the RF DC rectifier 21 according to the embodiment of the present invention receives an RF signal from an antenna ANT1 of a transmitter 10, and the RF DC rectifier 21 rectifies the received RF signal.

FIG. 3 is a waveform diagram of the RF signal and the DC output voltage in the RF DC rectifier. In FIG. 3, RFin represents the received RF signal. In this case, the RF signal is an On-OFF Keying (OOK) modulated signal, and DVout represents the rectified output signal.

The operation and effect of the present invention will be described below in detail with reference to the accompanying drawings.

The RF DC rectifier according to the embodiment of the present invention will be described with reference to FIGS. 1 through 3. Referring to FIG. 1, the RF DC rectifier includes the rectification circuit 100 with the plurality of rectification units 100-1, 1002, . . . , 100-n sequentially rectifying an RF signal input through the first input terminal IN1 and the second input terminal IN2.

The first rectification unit 100-1 rectifies the RF signal input through the first and second input terminals IN1 and IN2, and supplies the rectified voltage as the bias voltage of the second rectification unit 100-2.

The second rectification unit 100-2 is biased by the bias voltage output from the first rectification unit 100-1, rectifies the RF signal input through the first and second input terminals IN1 and IN2, and supplies the rectified voltage as the bias voltage of the next rectification unit.

By repeating those operations, the n-th rectification unit 100-n is biased by the bias voltage output from the immediately preceding rectification unit, rectifies the RF signal input through the first and second input terminals IN1 and IN2, and outputs the DC voltage through the rectification output terminal OUTn.

In case where the RF DC rectifier further includes the voltage limiter unit 200, the voltage limiter unit 200 limits a voltage above a preset voltage among the voltages output through the output terminal OUTn of the rectification circuit 100.

Therefore, when an overvoltage is applied through the first and second input terminals IN1 and IN2, it is limited to below the preset voltage by the voltage limiter unit 200. Thus, a system employing the RF DC rectifier according to the embodiment of the present invention can be protected from the overvoltage.

The RF DC rectifier according to the embodiment of the present invention will be described in more detail with reference to FIG. 1.

First, the RF signal is an AC signal having a positive RF signal and a negative RF signal. The negative RF signal is charged into the first input capacitor CI1 through the first parallel MOS transistor M11 of the first rectification unit 100-1, and the positive RF signal is charged into the first output capacitor CO1 through the first input capacitor C11 and the first serial MOS transistor M12. Through those operations, the voltage charged into the first output capacitor CO1 is increased, and the bias voltage is supplied to the second rectification unit 100-2.

Next, the negative RF signal is charged into the second input capacitor CI2 through the second parallel MOS transistor M21 of the second rectification unit 100-2, and the positive RF signal is charged into the second output capacitor CO2 through the second input capacitor CI2 and the second serial MOS transistor M22. Through those operations, the voltage charged into the second output capacitor CO2 is increased, and the bias voltage is supplied to the third rectification unit 100-3.

In the same manner as the operations of the first and second rectification units 100-1 and 100-2, the negative RF signal is charged into the n-th input capacitor CIn through the n-th parallel MOS transistor Mn1 of the n-th rectification unit 100-n, and the positive RF signal is charged into the n-th output capacitor COn through the n-th input capacitor CIn and the n-th serial MOS transistor Mn2. Through those operations, the voltage charged into the n-th output capacitor COn is increased and supplied through the rectification output terminal OUTn.

As described above, the first to n-th parallel MOS transistors M21, M21, . . . , Mn1 may be native transistors, and the first to n-th serial MOS transistors M12, M22, . . . , Mn2 may be native transistors.

The native transistor is supported in a CMOS process, has a native threshold voltage of about 0.05 V, and can be turned on at a small DC input. The sensitivity is increased and the operation length is increased. Thus, the RF DC conversion efficiency can be increased.

The voltage limiter unit 200 will be described below in more detail with reference to FIG. 1.

Referring to FIG. 1, when the voltage limiter unit 200 includes the voltage detecting unit 210 and the voltage blocking unit 220, the voltage detecting unit 210 includes a plurality of diode-connected MOS transistors connected in series between the first output terminal OUT+ connected to the rectification output terminal OUTn and the second output terminal OUT-connected to the second input terminal IN2.

Each source of the MOS transistors is connected to the first output terminal OUT+, and each drain of the MOS transistors is connected to the second output terminal OUT−. Since the MOS transistors are diode-connected, all the MOS transistors of the voltage detecting unit 210 are turned on when the overvoltage of the rectification output terminal OUTn is higher than the turn-on voltage of the MOS transistors. At this point, the voltage applied to the middle node MN among the MOS transistors of the voltage detecting unit 210 turns on the switching MOS transistor of the voltage blocking unit 220 and thus the overvoltage of the rectification output terminal OUTn is bypassed to the ground through the switching MOS transistor of the voltage blocking unit 220.

Referring to FIG. 2, the RF DC rectifier 21 according to the embodiment of the present invention can be applied to the wake-up receiver 21. As illustrated in FIG. 2, when the RF DC rectifier 21 according to the embodiment of the present invention is applied to the wake-up receiver 20, it rectifies the RF signal received through the antenna ANT1 of the transmitter 10 and outputs the DC voltage.

For example, as illustrated in FIG. 3, when the RF signal RFin is OOK-modulated, the RF signal is rectified by the RD DC rectifier and the rectified output signal DVout is outputted.

According to the embodiments of the present invention, since the RF DC rectifier operates only at desired time, the current consumption becomes ultra-low and the lifetime of the battery is extended. The CMOS IC and ultra-low power operation (<1 μA) are possible. Thus, the RF ID tag receiver function and the system wake-up function make it possible to increase system compatibility. Furthermore, since additional circuits for the reference voltage of the comparator are not needed, the circuit size can be reduced but the whole sensitivity of the wake-up system can be increased.

Moreover, since the repetitive rectification structure is implemented by using the native transistors, the RF signal for the wake-up can be rectified at ultra-low power (1 μA or less).

While the present invention has been shown and described in connection with the exemplary embodiments, it will be apparent to those skilled in the art that modifications and variations can be made without departing from the spirit and scope of the invention as defined by the appended claims.

What is claimed is:

1. A low-power radio frequency (RF) direct current (DC) rectifier, comprising:
a rectification circuit comprising first and second to n-th rectification units sequentially rectifying an RF signal input through a first input terminal and a second input terminal,
wherein the first rectification unit is disposed between the first and second input terminals and a first output terminal of the first rectification unit, and rectifies the RF signal and supplies the rectified RF signal to the second rectification unit;
the second rectification unit is disposed between the first rectification unit and a second output terminal of the second rectification unit, is biased by the rectified voltage output from the first rectification unit, rectifies the RF signal and supplies the rectified RF signal to an immediately following rectification unit; and
the n-th rectification unit is disposed between an immediately previous rectification unit and a rectification output terminal of the rectification circuit, is biased a rectified voltage output from an immediately preceding rectification unit, and rectifies the RF signal and outputs the rectified RF signal through the rectification output terminal.

2. The low-power RF DC rectifier of claim 1, wherein the first rectification unit comprises:
a first input capacitor having one terminal connected to the first input terminal;
a first parallel MOS transistor having a source connected to the other terminal of the first input capacitor, and a drain and a gate connected to the second input terminal;
a first serial MOS transistor having a drain and a gate connected to the other terminal of the first input capacitor, and a source connected to the first output terminal; and
a first output capacitor connected between the first output terminal and the second input terminal.

3. The low-power RF DC rectifier of claim 2, wherein the second rectification unit comprises:
a second input capacitor having one terminal connected to the first input terminal;
a second parallel MOS transistor having a source connected to the other terminal of the first input capacitor, and a drain and a gate connected to the second output terminal;
a second serial MOS transistor having a drain and a gate connected to the other terminal of the second input capacitor, and a source connected to the second output terminal; and
a second output capacitor connected between the second output terminal and the second input terminal.

4. The low-power RF DC rectifier of claim 3, wherein the n-th rectification unit comprises:
an n-th input capacitor having one terminal connected to the first input terminal;
an n-th parallel MOS transistor having a source connected to the other terminal of the n-th input capacitor, and a drain and a gate connected to the rectification output terminal;
an n-th serial MOS transistor having a drain and a gate connected to the other terminal of the n-th input capacitor, and a source connected to the rectification output terminal; and
an n-th output capacitor connected between the n-th output terminal and the second input terminal.

5. The low-power RF DC rectifier of claim 4, wherein the first to n-th parallel MOS transistors are native transistors, and the first to n-th serial MOS transistors are native transistors.

6. The low-power RF DC rectifier of claim 1, further comprising a voltage limiter unit, wherein the voltage limiter comprises:
a voltage detecting unit comprising a plurality of diode-connected MOS transistors connected between a first output terminal connected to the rectification output terminal and a second output terminal connected to the second input terminal, the diode-connected MOS transistors having sources connected to the first output terminal, drains connected to the second output terminals; and
a voltage blocking unit comprising a switching MOS transistor having a gate connected to a preset middle node among the MOS transistors of the voltage detecting unit, a drain connected to the first output terminal, and a source connected to the second output terminal.

7. A low-power radio frequency (RF) direct current (DC) rectifier, comprising:
a rectification circuit comprising first and second to n-th rectification units sequentially rectifying an RF signal input through a first input terminal and a second input terminal; and
a voltage limiter unit limiting a voltage above a preset voltage among voltages output from an output terminal of the rectification circuit,
wherein the first rectification unit is disposed between the first and second input terminals and a first output terminal of the first rectification unit, and rectifies the RF signal and supplies the rectified RF signal to the second rectification unit;
the second rectification unit is disposed between the first rectification unit and a second output terminal of the second rectification unit, is biased by the rectified voltage output from the first rectification unit, and rectifies the RF signal and supplies the rectified RF signal to an immediately following rectification unit; and
the n-th rectification unit is disposed between an immediately previous rectification unit and a rectification output terminal of the rectification circuit, is biased by a rectified voltage output from an immediately preceding rectification unit, and rectifies the RF signal and outputs the rectified RF signal through the rectification output terminal.

8. The low-power RF DC rectifier of claim 7, wherein the first rectification unit comprises:
a first input capacitor having one terminal connected to the first input terminal;
a first parallel MOS transistor having a source connected to the other terminal of the first input capacitor, and a drain and a gate connected to the second input terminal;
a first serial MOS transistor having a drain and a gate connected to the other terminal of the first input capacitor, and a source connected to the first output terminal; and
a first output capacitor connected between the first output terminal and the second input terminal.

9. The low-power RF DC rectifier of claim 8, wherein the second rectification unit comprises:
a second input capacitor having one terminal connected to the first input terminal;
a second parallel MOS transistor having a source connected to the other terminal of the first input capacitor, and a drain and a gate connected to the second output terminal;
a second serial MOS transistor having a drain and a gate connected to the other terminal of the second input capacitor, and a source connected to the second output terminal; and
a second output capacitor connected between the second output terminal and the second input terminal.

10. The low-power RF DC rectifier of claim 9, wherein the n-th rectification unit comprises:
an n-th input capacitor having one terminal connected to the first input terminal;
an n-th parallel MOS transistor having a source connected to the other terminal of the n-th input capacitor, and a drain and a gate connected to the rectification output terminal;
an n-th serial MOS transistor having a drain and a gate connected to the other terminal of the n-th input capacitor, and a source connected to the rectification output terminal; and
an n-th output capacitor connected between the n-th output terminal and the second input terminal.

11. The low-power RF DC rectifier of claim 7, wherein the voltage limiter unit comprises:
a voltage detecting unit comprising a plurality of diode-connected MOS transistors connected between a first output terminal connected to the rectification output terminal and a second output terminal connected to the second input terminal, the diode-connected MOS transistors having sources connected to the first output terminal, drains connected to the second output terminals; and
a voltage blocking unit comprising a switching MOS transistor having a gate connected to a preset middle node among the MOS transistors of the voltage detecting unit, a drain connected to the first output terminal, and a source connected to the second output terminal.
